(19) United States
(12) Patent Application Publication
(10) Pub. No.: US 2025/0282232 A1
(43) Pub. Date: Sep. 11, 2025

(54) METHOD FOR CONTROLLING AN ELECTRODYNAMIC BRAKE APPARATUS OF A RAIL VEHICLE

(71) Applicant: Siemens Mobility GmbH, München (DE)

(72) Inventors: Christian Foerth, Erlangen (DE); Lennart Kilian, Gauting (DE); Stefan Koch, Gerhardshofen (DE); Norbert Lang, Fürth (DE); Niklas Rüger, Rosstal (DE); Hans Friedrich Steffani, Nürnberg (DE)

(21) Appl. No.: 18/861,292

(22) PCT Filed: Apr. 3, 2023
(86) PCT No.: PCT/EP2023/058698

§ 371 Date: Oct. 29, 2024

(30) Foreign Application Priority Data
Apr. 29, 2022 (DE) 10 2022 204 252.2

(51) Int. Cl. B60L 15/20; B61H 7/04

(52) U.S. Cl. CPC B60L 15/2009; B61H 7/04; B60L 2200/26; B60L 2220/14; B60L 2240/423

(57) ABSTRACT

A method controls an electrodynamic brake apparatus of a rail vehicle. The electrodynamic brake apparatus contains, as parts of a drive system: an electric drive motor; a converter that is electrically connected to the motor and has a plurality of power semiconductor switches; and a controller that controls the power semiconductor switches. The power semiconductor switches of the converter are controlled according to a first control algorithm of the controller during emergency braking to generate a target braking torque, the first control algorithm including functions both of driving and of braking of the drive system. During the braking process, an actual braking toque generated by the electrodynamic brake apparatus is determined and compared with the target braking torque. On the basis of the comparison, the power semiconductor switches of the converter are controlled by a second control algorithm of the controller, the second control algorithm including exclusively functions of braking.

The invention relates to a method for controlling an electrodynamic brake apparatus of a rail vehicle, a drive system of a rail vehicle with such an electrodynamic brake apparatus, and a rail vehicle.

Electrically driven rail vehicles, in particular for local, regional and mainline transport, are preferably braked by means of electrodynamic brake apparatuses during a braking operation, since these can advantageously be operated in a virtually wear-free manner in comparison with friction brakes, in addition to which electrical energy that is generated during the braking operation can be fed into the electrical supply network, for example an overhead line or so-called third rail, which provides the electrical energy that is required for the drive.

The deployment of the electrodynamic brake apparatus is however limited to so-called service braking, while in the case of quick-action braking, also known as emergency braking, for the safety of passengers inside the rail vehicle and third parties outside the rail vehicle, use is made of additionally available friction brake apparatuses in order to initiate a braking operation with maximum braking torque. The deployment of friction brake apparatuses as opposed to the otherwise deployed electrodynamic brake apparatuses is based in this case on the conventionally greater failure protection of the friction brake apparatuses. However, it is therefore disadvantageously necessary to equip rail vehicles with both electrodynamic brake apparatuses and friction brake apparatuses which allow reliable quick-action braking from the maximum speed of the rail vehicle, this resulting in a high degree of technical complexity, particularly in the case of high-speed trains, additional weight, and in particular high costs for manufacture and operation.

It has therefore been endeavored for some time to increase the failure protection of the electrodynamic brake apparatuses of rail vehicles to the extent that these, based on evidence provided to an approvals body or organization in respect of an adequate degree of failure protection thereof, are also approved for quick-action braking. Such an approval would advantageously result in the ability to realize friction brake apparatuses with lower technical overheads and therefore lower achievable weight due to a significant reduction in the required braking torque. Such friction brakes could in this case be limited in particular to the function of stopping brakes, which act at low speeds and when stationary.

For example, the unexamined German application DE 10 2012 203 132 A1 already discloses the provision of two brake control units in order to increase the failure protection of an electrodynamic brake apparatus, wherein in a first braking mode a first brake control unit controls a power supply unit to provide a braking effect and, by means of a switching unit, a braking effect monitoring unit switches into a second braking mode as a function of a braking effect parameter, in which a second brake control unit controls the power supply unit to provide a braking effect. By virtue of providing two brake control units between which switching is possible, redundancy is achieved which increases the failure protection, wherein the brake control units can differ in particular in terms of diverse redundancy with regard to their structural and/or algorithmic embodiment. The provision of a second brake control unit together with a switching unit disadvantageously results in not only an increased number of units but also a requirement for supplementary evidence of an adequate degree of failure protection for these additional units.

The object of the invention is therefore to specify a method and an electrodynamic brake apparatus which ensure an adequate degree of failure protection of the electrodynamic brake apparatus, particularly in the case of quick-action braking. This object is achieved by the respective features in the independent claims. Developments are specified in the respective dependent claims.

A first aspect of the invention relates to a method for controlling an electrodynamic brake apparatus of a rail vehicle, said electrodynamic brake apparatus of the rail vehicle comprising at least one electric drive motor, a converter which is electrically connected thereto and has a plurality of power semiconductor switches, and a control device which controls the plurality of power semiconductor switches, as parts of a drive system of the rail vehicle. The method according to the invention is characterized in that in the event of quick-action braking, for the purpose of generating a target braking torque, the power semiconductor switches of the converter are controlled according to a first control algorithm of the control device, said first control algorithm comprising functions for both driving and braking the drive system, and during the braking operation an actual braking torque generated by the electrodynamic brake apparatus is determined and compared with the target braking torque and, on the basis of the comparison, the power semiconductor switches of the converter are controlled by means of a second control algorithm of the control device, said second control algorithm comprising functions exclusively for braking.

According to the invention, the failure protection of the electrodynamic brake apparatus of a rail vehicle is advantageously increased because a different, second control algorithm is used as a fall-back level for the control of the power semiconductor switches of the converter, said second algorithm having reduced complexity or reduced functional scope. For a thus reduced control algorithm, the evidence of an adequate degree of failure protection can be provided more easily. Moreover, in comparison with the solution according to the unexamined German application DE 10 2012 203 132 A1 described in the introduction, there is advantageously no need for a redundant or even diversely redundant control device, whereby the complexity of the brake apparatus and the costs are advantageously reduced in comparison with this known solution.

The reduced complexity or reduced functional scope of the second control algorithm is inventively achieved in that it comprises exclusively functions which are concerned with the generation of a braking torque or with the generation of a maximum braking torque when quick-action braking is requested. This means that the second control algorithm does not use active pointers of pulse width modulation, for example, by means of which the drive motor embodied as a three-phase machine is controlled. Consequently excluded are, for example, a return feed into the supply network, generation of a low braking torque, this being advantageous at low speeds in particular, rapid variation of the braking torque, this being advantageous for wheel slip protection in particular, and the generation of a drive torque.

The second control algorithm is used solely as a fall-back level for the electrodynamic brake apparatus in the rarely occurring error event that, during quick-action braking, the required actual braking torque cannot be generated by means of the first control algorithm. It follows conversely that in general the full functional scope of the first control algorithm can advantageously also be deployed when quick-action braking is requested. In this way, these functions allow, for example, an effective dynamic performance in respect of the braking torque that is generated, whereby it is possible to realize slip protection and braking to a low speed in particular, as well as a return feed into the supply network if the drive system is connected thereto and the supply network is able to receive the generated electrical energy.

The actual braking torque generated by the electrodynamic brake apparatus during a braking operation corresponds to the braking force that can be transferred from the drive motor to a wheelset which is mechanically connected thereto, usually via a single-stage or multi-stage transmission and a coupling, said wheelset comprising an axle and two wheels which are rigidly connected thereto and are supported on rails. The actual braking torque is determined by the supervisory control device, for example, which also performs the comparison of the determined actual braking torque with the target braking torque. The determination of the actual braking torque that is generated or can be generated is effected, for example, with reference to the power at the connection terminals of the drive motor. Alternatively or additionally, the actual braking torque can also be determined, for example, with reference to a negative acceleration, which can be derived from the observation of a change in the speed of the rail vehicle, this being captured, for example, by means of one or more speed sensors on a motor and/or axle, or from signals of one or more acceleration sensors. The actual braking torque can also be determined on the basis of a torque acting on a torque bracket of the drive motor. Redundant or diversely redundant information is preferably used for the purpose of determining the actual braking torque, in order to ensure an adequate degree of failure protection here likewise.

The target braking torque, as a function of whose value the control device controls the power semiconductor switches of the converter by means of the first control algorithm, is provided to the control device, for example, by a supervisory control device which is connected thereto for signaling purposes. In the case of a request for quick-action braking, this target braking torque corresponds initially, for example,. to a maximum braking torque that can be provided by the electrodynamic brake apparatus. In this case, the request for quick-action braking can be initiated manually by the person driving the vehicle or automatically, for example.

According to a first development of the method according to the invention, the second control algorithm has a narrower functional scope than the first control algorithm in respect of the braking function.

According to a further development of the method according to the invention, in the comparison step, the actual braking torque as determined is compared with a threshold value that is dependent on the target braking torque and, if the actual braking torque is less than the threshold value, the power semiconductor switches of the converter are controlled by means of the second control algorithm.

A suitable threshold value provided by the supervisory control device for the comparison corresponds to the target braking torque, for example, but can alternatively lie below the target braking value and have a specified relative interval, in particular a percental interval, or a specified absolute interval therefrom. By defining a threshold value which is lower than the target braking torque, it is advantageously possible to ensure that slight deviations of the determined actual braking torque from the target braking torque do not immediately result in activation of the second control algorithm with reduced functional scope.

According to a further development of the method according to the invention, the power semiconductor switches of the converter are controlled by means of the second control algorithm of the control device until the quick-action braking is complete.

A second aspect of the invention relates to an electric drive system of a rail vehicle, which drive system has at least one electrodynamic brake apparatus comprising at least one electric drive motor, a converter which is electrically connected thereto and has a plurality of power semiconductor switches, and a control device that controls the plurality of power semiconductor switches. The electric drive system is characterized in that the electrodynamic brake apparatus is embodied so as to carry out the method according to the first aspect of the invention.

According to a first development of the drive system according to the invention, the at least one drive motor is embodied as a permanent magnet-excited three-phase synchronous motor.

According to a further development of the drive system according to the invention, the at least one converter is embodied as a pulse-controlled inverter.

According to a further development of the drive system according to the invention, the electrodynamic brake apparatus also has a further, supervisory control device for the control device, said further control device being embodied in particular to specify the target braking torque to the control device and/or to perform the comparison of the determined actual braking torque with the target braking torque.

A third aspect of the invention relates finally to a rail vehicle, said rail vehicle being characterized in that it has at least one electrodynamic brake apparatus, which is embodied to carry out the method according to the first aspect of the invention, or at least one drive system according to the second aspect of the invention.

According to a development of the rail vehicle according to the invention, this is embodied as a high-speed multiple unit.

The invention is explained below with reference to exemplary embodiments, in which:

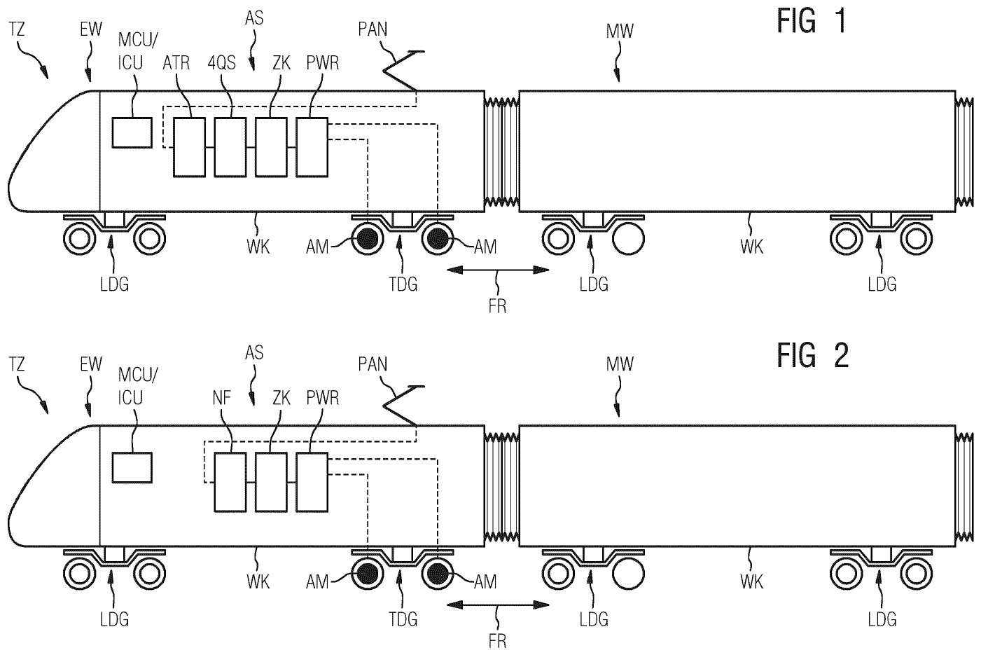

FIG. 1 shows a rail vehicle with an electric drive system for operation using an AC supply network,

FIG. 2 shows a rail vehicle with an electric drive system for operation using a DC supply network,

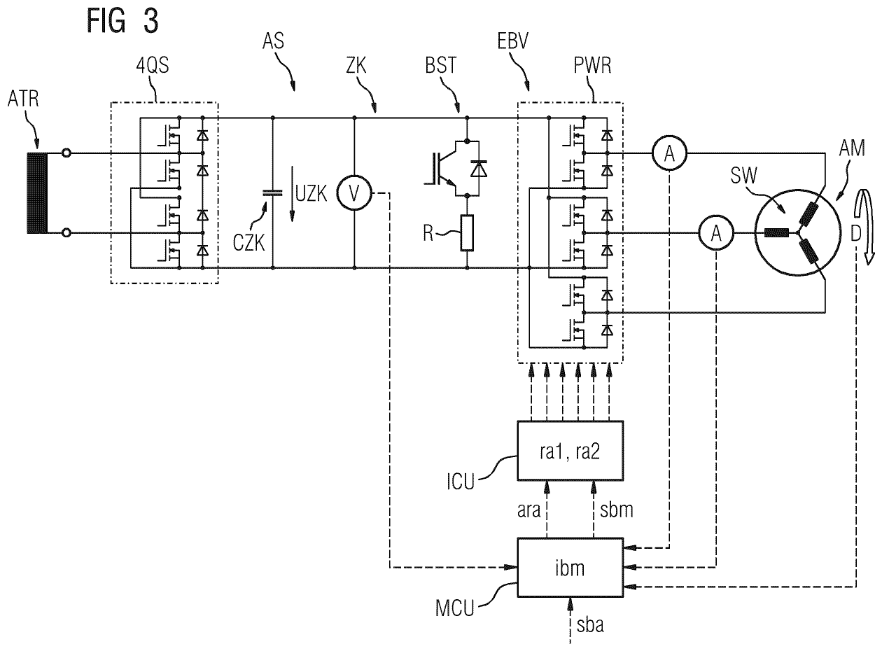

FIG. 3 shows the drive system of the rail vehicle according to FIG. 1, with devices of the inventive electrodynamic brake apparatus, and

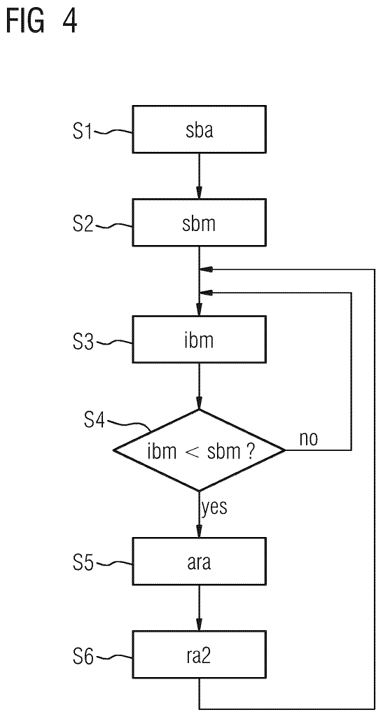

FIG. 4 shows a sequence diagram of the inventive method.

For reasons of clarity, the same reference signs are used in the figures for identical components or components which work in an identical or almost identical manner.

FIG. 1 schematically shows a rail vehicle TZ in a side view. The rail vehicle TZ is embodied by way of example as a multiple unit having a plurality of cars for passenger transport, only one end car EW and one center car MW which is coupled thereto being illustrated. Both cars have a respective car body WK which is supported on rails (not shown) of a track via bogies in the form of a motor bogie TDG with drive motors AM arranged therein or load-bearing bogies LDG without traction motors. The rail vehicle TZ moves on the rails in the indicated directions of travel FR.

Schematically indicated in the end car EW are components of an electric drive system AS of a rail vehicle TZ which is operated using an AC supply network. These components are usually arranged in special regions within the car body WK, in the underfloor region, the roof region, or even distributed over a plurality of cars of the rail vehicle TZ. Further components of the drive system AS, in particular auxiliary units required for operation of the components, are likewise provided but are not specifically illustrated in FIG. 1.

By means of a pantograph PAN which is arranged in the roof region of the end car EW, for example, the drive train AS can be electrically connected to an overhead line (not shown) of the AC supply network, said overhead line carrying a single-phase alternating current, for example. The alternating current is supplied to a supply-side primary winding of a drive transformer ATR, in which the supply-side voltage level of, for example, 15 kV, 16.7 Hz 9 or 25 kV, 50 Hz is transformed to a lower voltage level. A secondary winding of the drive transformer ATR is connected to a supply-side converter 4QS, for example a four-quadrant converter, which rectifies the alternating current.

The supply-side converter 4QS supplies a DC voltage intermediate circuit ZK, which in turn supplies a load-side converter PWR, for example a pulse-controlled inverter. Arranged in the DC voltage intermediate circuit ZK are one or more intermediate circuit capacitors, which are used as electrical energy stores in particular to smooth the DC voltage. From the DC voltage of the DC voltage intermediate circuit ZK, the load-side converter PWR generates a three-phase AC voltage of variable frequency and amplitude, with which the stator windings of, for example, two drive motors TM arranged in the motor bogie TDG of the end car EW are supplied. The function of in particular the supply-side converter 40S and the load-side converter PWR is controlled by a control device ICU, it being alternatively possible to provide individual control devices for the converters.

FIG. 2 schematically shows a rail vehicle TZ which corresponds to the rail vehicle TZ according to FIG. 1 but has an alternative drive system AS. In this example, the pantograph PAN can be connected to an overhead line (again not shown) of a DC supply network. In the local transport region in particular, arranged parallel to the track instead of an overhead line is a live rail to which the drive train AS can be connected via one or a plurality of lateral current collectors, these being arranged in the vicinity of the car body ends or the bogies, for example. The direct current of the supply network is supplied via an input filter or network filter NF to the DC voltage intermediate circuit ZK of the drive system AS. The network filter NF comprises, for example, a filter inductor in the form of a choke, and a capacitor, which capacitor can additionally perform the function of an intermediate circuit capacitor ZK of the drive train AS.

FIG. 3 schematically shows the exemplary drive system AS of the rail vehicle TZ according to FIG. 1, without all previously described components of the system being illustrated again. For example, only a secondary winding of the drive transformer ATR supplied by an AC supply network is included and only one drive motor AM is shown.

In the drive system AS, the secondary winding of the drive transformer ATR is connected to the supply-side converter 4QS. The supply-side converter 4QS is embodied as a four-quadrant converter, which converts the AC voltage supplied by the drive transformer ATR on the input side into a DC voltage and supplies this on the output side. The conversion in this case is effected by controlling power semiconductor switches or power transistors, said power semiconductor switches being realized on the basis of, for example, silicon or a semiconductor having a greater energy gap than silicon, in particular silicon carbide (SiC), gallium nitride (GaN) or diamond. Two power transistors in each case are connected electrically in series in a switch branch, whose central connection point is connected to a respective input of the supply-side converter 4QS. The outer connection points of the switch branches are connected to a respective output of the supply-side converter 4QS.

Via the outputs thereof, the supply-side converter 4QS supplies a DC voltage intermediate circuit ZK, which is in turn connected to inputs of the load-side converter PWR. Arranged in the DC voltage intermediate circuit ZK is, for example an intermediate circuit capacitor CZK at which an intermediate circuit voltage UZK is present. Alternatively to the one intermediate circuit capacitor CZK shown, a plurality of intermediate circuit capacitors CZK can also be connected electrically in parallel in order to provide a desired capacitance. Also arranged in parallel with the intermediate circuit capacitor CZK in the DC voltage intermediate circuit ZK is a braking controller BST, which comprises, for example, a series connection of a controllable switch and a resistor R.

The load-side converter PWR is embodied as a pulse-controlled inverter, for example, which converts the DC voltage that is present on the input side into an AC voltage of variable amplitude and frequency, and provides this at outputs. The conversion is effected by controlling the power semiconductor switches or power transistors via a control device ICU, said power semiconductor switches again being realized, for example, on the basis of silicon or a semiconductor having a greater energy gap than silicon, in particular silicon carbide (SiC), gallium nitride (GaN) or diamond. In contrast with the supply-side converter 4QS, for the three phases for example of the stator winding SW of the drive motor AM, the load-side converter PWR has three or a whole-number multiple of three parallel switch branches with respectively two power semiconductor switches connected in series, to each of which a so-called freewheeling diode is connected in an antiparallel manner.

The drive motor AM which is supplied by the load-side converter PWR is embodied as a separately excited three-phase asynchronous machine or preferably as a permanent magnet-excited three-phase synchronous machine.

The control device ICU controls the exemplary six power semiconductor switches of the load-side converter PWR according to a control algorithm ra1, signals of this control being indicated by six vertical broken-line arrows emerging from the control device ICU. The control device ICU receives signals from a supervisory control device MCU, which controls, for example, a plurality of or all control devices ICU of the drive system AS of the rail vehicle TZ, in particular specifications relating to a drive torque or braking torque, and converts these by means of a control algorithm, optionally taking further information into consideration.

FIG. 3 relates specifically to the case of initiating quick-action braking of the rail vehicle TZ. In this case, the supervisory control device MCU receives a quick-action braking request sba, the signaling of which was triggered, for example, by the person driving the rail vehicle TZ or even automatically by a safety system of the rail vehicle TZ. In response to the receipt of the quick-action braking request sba and depending on further information, in particular a current speed and current weight of the rail vehicle TZ, the supervisory control device MCU defines a target braking torque sbm, with which a maximum braking effect is to be achieved by the electrodynamic brake apparatus EBV. This target braking torque sbm is signaled by the supervisory control device MCU to the control device ICU which, by means of a first control algorithm ral, generates control instructions for the purpose of controlling the power semiconductor switches of the load-side converter PWR.

An actual braking torque ibm achieved by the electrodynamic brake apparatus EBV as a result of this control is determined by the supervisory control device MCU on the basis of various signals or information it receives. Such signals or information comprise or represent, for example, currents in the phases of the stator winding SW of the drive motor AM, said currents being determined, for example, by means of ammeters A which are arranged in or on motor cables. Alternatively or additionally, signals or information considered by the supervisory control device MCU can comprise or represent an intermediate circuit voltage UZK, which is determined, for example, by means of a volt meter V which is arranged in the DC voltage intermediate circuit ZK parallel to the intermediate circuit capacitor ZK, a rotational speed D of the drive motor AM, which is determined, for example, by means of a rotational speed sensor on the motor shaft of the drive motor AM, a speed or speed history which is determined by a central unit of the rail vehicle TZ, or an acceleration of the rail vehicle TZ which is measured by means of one or more acceleration sensors.

The supervisory control device MCU compares the determined actual braking torque ibm with the defined target braking torque sbm. If this comparison reveals that the actual braking torque ibm is less than the target braking torque sbm, a threshold value, for example, which is dependent on the target braking torque sbm being used for the comparison, the supervisory control device MCU sends a signal ara to the control device ICU to select a second control algorithm ra2, by means of which control instructions must then be generated to control the power semiconductor switches of the converter PWR. This second control algorithm ra2, which is stored in the control device ICU like the first control algorithm ra1, has a narrower functional scope than the first control algorithm ra1 in this case.

The components, devices and method steps described above can be similarly realized in a drive system AS corresponding to that of the rail vehicle TZ in FIG. 2, wherein this drive system AS has no supply-side converter or transformer as per the previous description but is electrically connected to a direct-current supply network via a network filter NF.

FIG. 4 schematically shows a sequence diagram of the inventive method based on the electrodynamic brake apparatus EBV according to FIG. 3, only steps relating to a request for quick-action braking being illustrated. Furthermore, at the starting situation of the sequence diagram, the control device ICU is using the first control algorithm ral, which comprises functions for both driving and electrodynamic braking of the drive system AS.

In a first step S1, the supervisory control device MCU receives a quick-action braking request sba. On the basis of this received request sba, in a second step S2 following thereupon, the supervisory control device MCU defines a target braking torque sbm and signals this to the control device ICU.

In a third step S3 following thereupon, the supervisory control device MCU determines an actual braking torque ibm achieved by the electrodynamic brake apparatus EBV, taking into account information that has been signaled or supplied. In a next fourth step S4, the supervisory control device MCU compares the determined actual braking torque ibm with the defined target braking torque sbm or with a threshold value derived therefrom. If this comparison reveals that the actual braking torque ibm is less than the target braking torque or falls below the target braking torque sbm by a determined relative or absolute amount (branch “yes”), in a fifth step S5 the supervisory control device MCU sends a signal ara to the control device ICU to select the second control algorithm ra2, which has a reduced functional scope in comparison with the first control algorithm ra1 used initially. However, if the determined actual braking torque ibm corresponds to the target braking torque or is not lower than a threshold value (branch “no”), the supervisory control device MCU continues to monitor or determine the current actual braking torque ibm.

As a result of receiving the selection signal ara from the supervisory control device MCU, in a subsequent sixth step S6 the control device ICU uses the second control algorithm ra2 to control the power semiconductor switches of the converter PWR.

1-10. (canceled)

11. A method for controlling an electrodynamic brake apparatus of a rail vehicle, the electrodynamic brake apparatus of the rail vehicle having at least one electric drive motor, a converter electrically connected to the electric drive motor and having a plurality of power semiconductor switches, and a controller controlling the plurality of power semiconductor switches, as parts of a drive system of the rail vehicle, which comprises the steps of:
controlling the power semiconductor switches of the converter according to a first control algorithm of the controller in an event of emergency braking, for generating a target braking torque, wherein the first control algorithm has functions for both driving and braking the drive system;
determining and comparing an actual braking torque generated by the electrodynamic brake apparatus with the target braking torque during a braking operation; and
controlling the power semiconductor switches of the converter by means of a second control algorithm of the controller on a basis of the comparison, wherein the second control algorithm has functions exclusively for braking.

12. The method according to claim 11, wherein the second control algorithm has a narrower functional scope than the first control algorithm in respect of a braking function.

13. The method according to claim 11, wherein in the comparing step, performing the sub-step of:
comparing the actual braking torque with a threshold value that is dependent on the target braking torque, and, if the actual braking torque is less than the threshold value, the power semiconductor switches of the converter are controlled by means of the second control algorithm.

14. The method according to claim 11, which further comprises controlling the power semiconductor switches of the converter by means of the second control algorithm of the controller until the emergency braking is complete.

15. An electric drive system of a rail vehicle, the electric drive system comprising:
at least one electrodynamic brake apparatus containing at least one electric drive motor, a converter being electrically connected to said at least one electric drive motor and having a plurality of power semiconductor switches, and a controller controlling said plurality of power semiconductor switches; and
said at least one electrodynamic brake apparatus embodied to carry out the method according to claim 11.

16. The drive system according to claim 15, wherein said at least one electric drive motor is a permanent magnet-excited three-phase synchronous motor.

17. The drive system according to claim 15, wherein said converter is a pulse-controlled inverter.

18. The drive system according to claim 15, wherein said at least one electrodynamic brake apparatus further has a supervisory controller for said controller, wherein said supervisory controller is embodied to specify the target braking torque to said controller and/or to perform a comparison of the actual braking torque with the target braking torque.

19. A rail vehicle, comprising:
at least one electrodynamic brake apparatus embodied for carrying out the method according to claim 11.

20. The rail vehicle according to claim 19, wherein the rail vehicle is a high-speed multiple unit.

21. A rail vehicle, comprising:
an electric drive system, containing:
at least one electrodynamic brake apparatus containing at least one electric drive motor, a converter being electrically connected to said at least one electric drive motor and having a plurality of power semiconductor switches, and a controller controlling said plurality of power semiconductor switches; and
said at least one electrodynamic brake apparatus embodied to carry out the method according to claim 11.

22. The rail vehicle according to claim 21, wherein the rail vehicle is a high-speed multiple unit.
